(19) United States
(12) Patent Application Publication
(10) Pub. No.: US 2020/0264768 A1
(43) Pub. Date: Aug. 20, 2020

(54) METHOD FOR PROVIDING A CODE INPUT INTERFACE TO A USER IN A SCREEN INTERACTIVE DEVICE

(71) Applicant: Tetsu Ota, Sagamihara-shi (JP)

(72) Inventor: Tetsu Ota, Sagamihara-shi (JP)

(73) Assignee: Life Labo Corp., Sagamihara-shi (JP)

(21) Appl. No.: 16/794,276

(22) Filed: Feb. 19, 2020

(30) Foreign Application Priority Data
Feb. 19, 2019 (JP) 2019-027838

(51) Int. Cl. G06F 3/0488; G06F 3/0489

(52) U.S. Cl. CPC G06F 3/04883; G06F 3/04897

(57) ABSTRACT

The invention concerns a method for providing a code input interface to a user by means of a twelve-keys arrangement consisted of three columns by four rows in a screen interactive device in which display on a screen changes and the user manipulates on the screen in accordance with the display of the screen. The method comprises:
providing a code input region for inputting codes on the screen, the code input region comprising n key regions, the codes are divided into n number of groups, each group including m or less codes as members;
allowing a flick manipulation of the user on the key region to m number of directions;
determining which kind of flick manipulation and on which key region the flick manipulation is performed; and
determining the code to be input according to the kind and the key region thus determined, wherein
the m types of flick manipulations to the m directions include three or more flick manipulations on either one of upper and lower sides, and
four or more flick manipulations to four or more directions are not used on either the upper or lower sides.

### CROSS REFERENCE TO RELATED APPLICATIONS

The present invention claims the benefit of priority to Japanese Patent Application No. 2019-027838 filed on Feb. 19, 2019, the entire contents of which are incorporated herein by reference in its entirety.

### TECHNICAL FIELD

The present invention relates to a method for providing a code input interface to a user in a screen interactive device such as a smartphone or tablet terminal.

### BACKGROUND ART

Rotary dials have been used to input telephone numbers, which are series of numbers, since Alexander Graham Bell invented a telephone in the US in 1876 but Bell System introduced in 1963 a keypad having a twelve-key arrangement with numbers, “*” and “#” assigned to keys arranged in three columns by four rows. In recent years, telephones have evolved, and screen interactive devices (SIDs) have become popular in which display on the screen changes and the users manipulate the device with, for example, touches using their fingers. Examples of screen interactive devices include smartphones and tablet terminals, which are equipped with batteries, are portable, and can be manipulated while carrying them.

In such a screen interactive device, there is a functionality to send text messages, and therefore it is important to make character input easier. For this purpose, it is important to make manipulations using user's fingers easier.

In relation to this, U.S. Pat. No. 8,902,179 assigned to Life Labo Corp. makes character input easier by having a left ⅓ region and a right ⅓ region in the screen as code input regions, making it easier to perform flick manipulations in these areas (see FIG. 17 in this U.S. Patent).

### SUMMARY OF THE INVENTION

The present invention aims to make character input easier in both portrait and landscape display modes in screen interactive devices.

The invention concerns a method for providing a code input interface to a user in a screen interactive device in which display on a screen changes and the user manipulates on a screen in accordance with the display of the screen, the method comprising: providing a code input region consisted of a left column group, one or two center columns, and a right column group and consisted of a plurality of key regions; determining which key region is manipulated by the user in response to an input manipulation performed by the user; and determining a code to be input in accordance with the determination of the key region.

According to an aspect of the invention, the m types of flick manipulations to the m directions include three or more flick manipulations on either one of upper and lower sides, and four or more flick manipulations to four or more directions are not used on either the upper or lower sides.

According to an aspect of the invention, the screen interactive device displays the code input region on the screen of the screen interactive device in a portrait display mode and in a landscape display mode, the screen having a substantially rectangular shape, and in the landscape display mode, width of the one or two center columns in the code input region is enlarged as compared to the portrait display mode at an increase rate larger than that of the width of the columns in the left column group and the right column group. Examples of “code” include a character, a number, a symbol, a pictograph (emoji), and the like.

According to an aspect of the invention, the user can set the size of the width of the center column.

According to an aspect of the invention, the center column is consisted of one column.

According to an aspect of the invention, each of the left column group and the right column group consists of one column, and the code input region includes twelve regions arranged in three columns by four rows, the twelve regions being substantially rectangular overall.

According to an aspect of the invention, the code input region includes 26 regions corresponding to 26 alphabets from A to Z, and the one or two center columns include regions corresponding to three characters of Y or Z, H, and N, and/or three characters of T, G, and B.

According to an aspect of the invention, a space code is input by flicking manipulation on the key region constituting the center column.

According to an aspect of the invention, the invention concerns a method for providing a code input interface to a user in a screen interactive device in which display on a screen changes and the user manipulates on the screen in accordance with the display of the screen, the method comprising: providing a code input region for inputting codes on the screen, the code input region comprising n key regions, the codes are divided into n number of groups, each group including m or less codes as members; allowing a flick manipulation of the user on the key region to m number of directions; determining which kind of flick manipulation and on which key region the flick manipulation is performed; and determining the code to be input according to the kind and the key region thus determined, wherein the m types of flick manipulations to the m directions include three or more flick manipulations on either one of upper and lower sides, and four or more flick manipulations to four or more directions are not used on either the upper or lower sides.

According to an aspect of the invention, n is 9 or 10, m is 5 or 6, Japanese hiragana characters are assigned to the n key regions, the n key regions respectively correspond to at least “a” gyo, “ka” gyo, “sa” gyo, “ta” gyo, “na” gyo, “ha” gyo, “ma” gyo, “ya” gyo, “ra” gyo and “wa” gyo of Japanese hiragana characters, and the m directions are five directions consisted of upper-left, up, upper-right, lower-left, and lower-right directions, or six directions consisted of upper-left, up, upper-right, lower-left, down and lower-right directions.

According to an aspect of the invention, n is 9 or 10, m is 6, Japanese hiragana characters and numbers 0 to 9 are assigned to the n key regions, the n key regions respectively correspond to at least “a” gyo hiragana characters and number “1”, “ka” gyo hiragana characters and number “2”, “sa” gyo hiragana characters and number “3”, “ta” gyo hiragana characters and number “4”, “na” gyo hiragana characters and number “5”, “ha” gyo hiragana characters and number “6”, “ma” gyo hiragana characters and number “7”, “ya” gyo hiragana characters and number “8”, “ra” gyo hiragana characters and number “9”, and “wa” gyo hiragana characters and number “0”, the m directions are six directions consisted of upper-left, up, upper-right, lower-left, down and lower-right directions, and “a” retsu hiragana characters (“a”, “ka”, “sa”, “ta”, . . . ), “i” retsu hiragana characters (“i”, “ki”, “si”, “ti”, . . . ), “u” retsu hiragana characters (“u”, “ku”, “su”, “tu”, . . . ), “e” retsu hiragana characters (“e”, “ke”, “se”, “te”, . . . ), “o” retsu hiragana characters (“o”, “ko”, “so”, “to”, . . . ), and numbers (“1”, “2”, “3”, “4”, . . . ) are respectively assigned to the upper-left, up, upper-right, lower-left, down and lower-right directions.

According to an aspect of the invention, n is 6-10, m is 3-12, alphabet characters are respectively assigned to one of n key regions, each of the n key regions corresponds to one of a first group, second group, . . . , nth group of alphabet characters, and the m directions are three to six directions selected from six directions consisted of upper-left, up, upper-right, lower-left, down and lower-right directions.

According to an aspect of the invention, the invention concerns a method for providing a code input interface to a user in a screen interactive device in which display on a screen changes and the user manipulates on the screen in accordance with the display of the screen, the method comprising: providing a code input region for inputting codes on the screen, the code input region comprising n key regions, the codes are divided into n number of groups, each group including m or less codes as members, m being an integer 6 or less; allowing a flick manipulation of the user on the key region to m number of directions; determining which kind of flick manipulation and on which key region the flick manipulation is performed; and determining the code to be input according to the kind and the key region thus determined.

According to an aspect of the invention, the invention concerns a method for providing a code input interface to a user in a screen interactive device in which display on a screen changes and the user manipulates on the screen in accordance with the display of the screen, the method comprising: providing a code input region for inputting codes on the screen, the code input region comprising n key regions, the codes belonging to the same kind of codes (e.g. alphabet), the number of codes being 20 or more, the codes are divided into n number of groups, each group including m or less codes as members, m being an integer 6 or less; allowing a flick manipulation of the user on the key region to m or more number of directions; determining which kind of flick manipulation and on which key region the flick manipulation is performed; and determining the code to be input according to the kind and the key region thus determined.

According to an aspect of the invention, n=6, m=5, the codes include twenty six alphabets, and the n number of groups are substantially grouped based on groups of each row in a plenteous-keys keyboard arrangement separated at a center. Therefore, in the case of alphabets, the codes are divided into six groups of QWERT, YUIOP, ASDFG, HJKL, ZXCVB and NM (In the case of German, Y and Z are switched). Among these characters, QWERT, YUIOP, ASDFG and ZXCVB are respectively divided into two subgroups of QW and ERT, YUI and OP, AS and DFG, and ZX and CVB. The method allows a flick manipulation of five or more flick manipulations to five or more directions by the user on key regions in a code input region including six key regions. Said five or more directions include three directions at the upper side and two directions at the lower side, or two directions at the upper side and three directions at the lower side. Said codes are assigned in accordance with said subgroups to said three directions at the upper side and said two directions at the lower side, or said two directions at the upper side and said three directions at the lower side. Of course, although the case of the alphabets is not specified in the above description, either one of uppercase and lowercase is output actually. This is the same in other description.

According to an aspect of the invention, n=6, m=5, the codes include twenty six alphabets, and the n number of groups are substantially grouped based on groups of each row in a plenteous-keys keyboard arrangement separated at a center. Therefore, in the case of alphabets, the codes are divided into six groups of QWERT, YUIOP, ASDFG, HJKL, ZXCVB and NM (In the case of German, Y and Z are switched). Among these characters, QWERT, YUIOP, ASDFG and ZXCVB are respectively divided into two subgroups of left subgroup and right subgroup in accordance with a lateral order. The method allows a flick manipulation of five or more flick manipulations to five or more directions by the user on key regions in a code input region including twelve key regions. Said key regions belonging to a group include a left key region and a right key region. Said left subgroup and said right subgroup belonging to a group are respectively assigned to said left key region and said right key region. Said flick manipulations for inputting said codes are substantially performed by flick manipulations to an upper side only or a lower side only. Thus, the codes can be input with flick manipulations to an upper side only (or lower side only) in the code input region, and therefore the user who has mastered a full keyboard arrangement can input codes similarly to touch scheme with larger key regions.

The invention also concerns a method for providing a code input interface to a user in a screen interactive device in which screen display changes and the user manipulates on the screen, the method comprising the steps of: providing a keyboard region comprising a plurality of key regions on the screen; determining, in response to a flick manipulation performed by the user on the key regions, which key region is manipulated in the keyboard region and which kind of manipulation is manipulated; and determining a code to be input in accordance with the determination of the key region and the kind of manipulation. According to an aspect of the invention, the keyboard region includes a left key region consisted of two or more columns at the left side and a right key region consisted of two or more columns at the right side in the portrait display mode, and the left key region is displayed at the left side and the right key region is displayed at the right side in the landscape display mode as well, and in the landscape display mode, width of an outermost column in the left key region and width of an outermost column in the right key region are enlarged as compared to the portrait display mode at an increase rate less than an increase rate of the width of innermost columns in the left and right key regions.

Ten numbers of 1, 2, 3, 4, 5, 6, 7, 8, 9 and 0 are assigned to ten key regions in the three columns by four rows keys that does not include one column at the right or left side in the keyboard region, respectively.

Codes on keys on a top row at a left side in a plenteous-keys keyboard arrangement are grouped into two groups and these two groups are respectively assigned to two keys on a first row in the left keyboard region. An example of “plenteous-keys keyboard arrangement” include QWERTY arrangement. Codes on keys on a top row at a left side in a QWERTY arrangement are Q, W, E, R and T. These characters are divided into QW and ERT, or QWE and RT so that Q, W and E are assigned to the left end key and R and T are assigned to the inner key of the left end key. Codes on keys on a center row at a left side in the plenteous-keys keyboard arrangement are grouped into two groups and these two groups are respectively assigned to two keys on a second row in the left keyboard region, codes on keys on a bottom row at a left side in the plenteous-keys keyboard arrangement are grouped into two groups and these two groups are respectively assigned to two keys on a third row in the left keyboard region, codes on keys on a top row at a right side in the plenteous-keys keyboard arrangement are grouped into two groups and these two groups are respectively assigned to two keys on a first row in the right keyboard region, codes on keys on a center row at a right side in the plenteous-keys keyboard arrangement are grouped into two groups and these two groups are respectively assigned to two keys on a second row in the right keyboard region, and codes on keys on a bottom row at a right side in the plenteous-keys keyboard arrangement are grouped into two groups and these two groups are respectively assigned to two keys on a third row in the right keyboard region. Since there are only N and M on keys on a bottom row at the right side in QWERTY arrangement, the arrangement of those characters are not specified. In all said assignments, at most three said codes are assigned to each key and the codes are determined according to flick manipulations to said different directions on the assigned key. Said directions are all either at the upper side or the lower side for codes belonging to the same kind. With these features, it is possible to input codes with a feeling close to a plenteous-keys keyboard arrangement.

“a” gyo hiragana characters including “a”, “i”, “u”, “e” and “ko”, “ka” gyo hiragana characters including “ka”, “ki”, “ku”, “ke” and “ko”, “sa” gyo hiragana characters including “sa”, “si”, “su”, “se” and “so”, “ta” gyo hiragana characters including “ta”, “ti”, “tu”, “te” and “to”, “na” gyo hiragana characters including “na”, “ni”, “nu”, “ne” and “no”, “ha” gyo hiragana characters including “ha”, “hi”, “hu”, “he” and “ho”, “ma” gyo hiragana characters including “ma”, “mi”, “mu”, “me” and “mo”, “ya” gyo hiragana characters including “ya”, “yu” and “yo”, “ra” gyo hiragana characters including “ra”, “ri”, “ru”, “re” and “ro”, “wa” gyo hiragana characters including “wa”, “wo” and “n” are respectively assigned to ten keys among keys in the three columns by four rows on the left or right side of the keyboard region.

### BRIEF DESCRIPTION OF THE DRAWINGS

FIGS. 1A, 1B and 1C show front views of a screen interactive device including screen views of center column widened configurations;

FIG. 2 shows a screen view of a landscape display according to the invention;

FIGS. 3A, 3B, 3C and 3D show screen views illustrating center column widened configurations in keyboards of QWERTY arrangements;

FIGS. 4A and 4B show screen views illustrating setting screens for widths of columns;

FIG. 5 shows a screen view illustrating a five-directions flick scheme for inputting alphabets;

FIG. 6 shows a screen view illustrating a six-directions flick scheme for inputting hiragana;

FIGS. 7A and 7B show screen views illustrating predicted candidate displays using “ambiguity narrowing schemes”;

FIGS. 8A, 8B and 8C show screen views illustrating an “ERT-QW flick scheme” for inputting alphabets;

FIGS. 9A, 9B and 9C show screen views illustrating a “ERT-QW flick scheme for one-handed manipulation” for inputting alphabets;

FIGS. 10A and 10B show screen views illustrating a “QW-ERT flick scheme” for inputting alphabets; and

FIGS. 11A, 11B and 11C show four-rows implementations of the “QW-ERT flick scheme” for inputting alphabets.

### DETAILS OF THE INVENTION

A first embodiment of the invention will be described now.

Screen interactive devices are often manipulated with the left hand holding the left end thereof and the right hand holding the right end thereof. Usually, one of vertical length and lateral length of a screen interactive device is longer than the other. For example, the one of vertical length and lateral length is twice as long as the other.

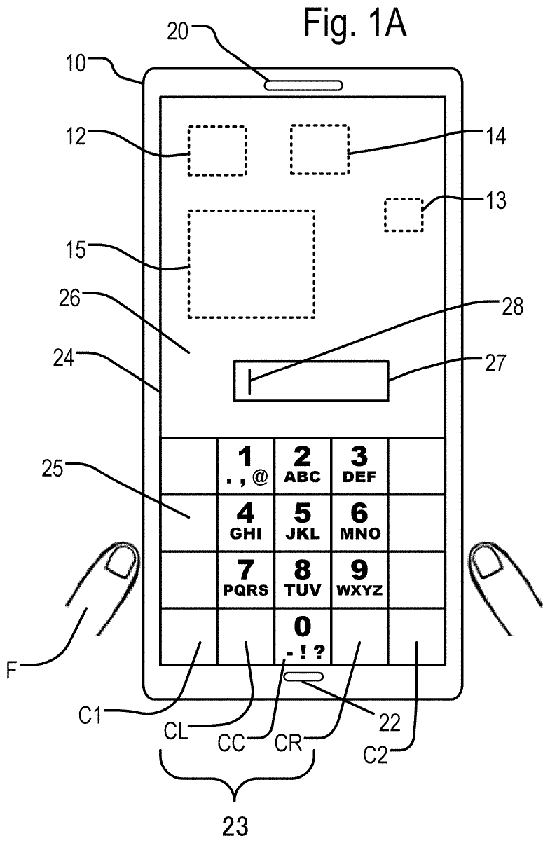

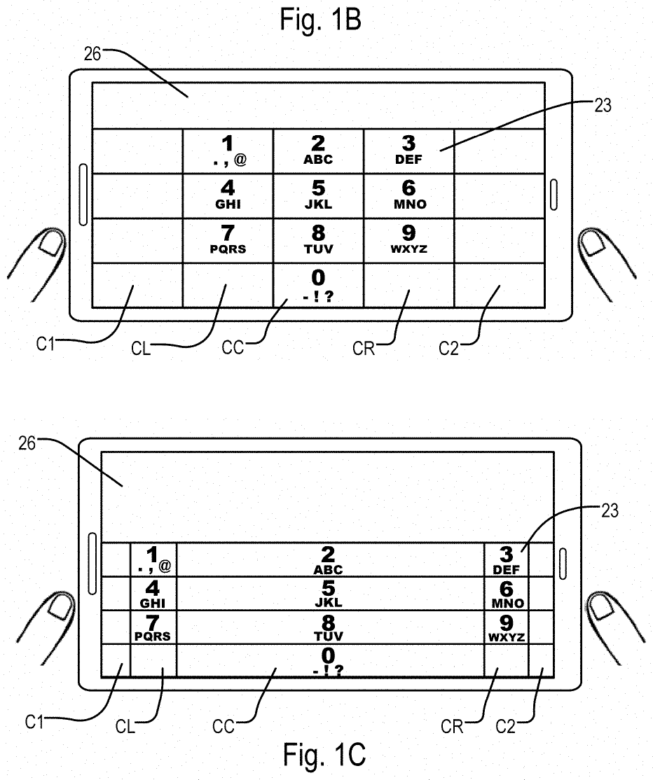

When manipulating a screen interactive device having a large screen with the left hand holding the left end and the right hand holding the right end, especially when the lengthwise axis is oriented in the horizontal direction (This display mode is referred to as “landscape display mode”), the central region of the screen interactive device may be difficult to manipulate with a finger since the central region is far from both the left end and the right end (see FIG. 1B). A display mode when the lengthwise axis is not oriented in the horizontal direction is referred to as “portrait display mode”.

It is desirable for a touch-type keyboard to have a key arrangement that is easy for the user to perform input manipulations on screen interactive devices of any size in both the portrait display mode and the landscape display mode.

In a smartphone or tablet terminal, the user initiates a telephone call by inputting numbers using twelve-keys. In such a device, numbers are assigned to keys arranged in three columns in the left-right direction. When inputting characters, a plenteous-keys keyboard such as QWERTY keyboard is used. A “plenteous-keys keyboard” refers to a keyboard with six or more keys for inputting characters in the horizontal direction. Preferably, “plenteous-keys keyboard” has eight or more keys for inputting characters in the horizontal direction.

FIG. 1A shows a front view of a screen interactive device used in the present invention. A screen interactive device 10 includes a processor 12, a posture sensor 13, a memory 14 and a battery 15 internally, and includes a speaker 20, a microphone 22, and a screen 24 that can be seen externally. There is a sensor layer on substantially the entire area of the screen 24, allowing the device to recognize touch manipulations, flick manipulations, swipe manipulations, drawing manipulations, and the like performed by the user using a finger F or the like. The definition of touch and flick manipulations is the same as that of the above U.S. Pat. No. 8,902,179. This Patent is incorporated herein by reference. A touch manipulation is done by touching an area in the screen and then releasing the finger or the like. A flick manipulation is done by touching a starting area in the screen and then moving the finger or the like in a certain direction. A flick manipulation can also be done by sliding the finger or the like in a certain direction from a certain starting area on the screen. The screen interactive device forms a main interface with the user by displaying objects on the screen 24 and recognizing user's actions taken against the objects.

In an initial situation where a screen of a particular Web page or a word processor application is displayed throughout the screen 24, the focus moves to a text box 27 after the user, for example, touches an inner area of the text box 27, and the cursor 28 blinks inside the text box 27 so that the user can identify the text entry point.

At this time, a keyboard region 25 newly appears in a part of the screen 24, making a part of the originally displayed page not displayed but the remaining part remains to be displayed in a non-keyboard region 26 (see FIG. 1A).

The keyboard region 25 is typically displayed and controlled by a character inputting software (IME: Input Method Editor). Examples of character inputting software include “Raku-uchi (formally, 2-Touch Character Input)” released by Life Labo Corp. for Android devices.

The keyboard region 25 in FIG. 1A has a five columns by four rows arrangement in general, with left end column C1, left column CL, center column CC, right column CR, and right end column C2 from the left side. Functional keys, such as left cursor movement, right cursor movement, backspace, enter/determination, space/conversion, and mode switching, are arranged in the left-hand row C1 or the right-hand row C2. The left column CL, the center column CC, and the right column CR form a code input region 23 of 3 columns by 4 rows. This is because the codes to be input are mainly selected using such columns CL, CC and CR. However, the key regions at the bottom of the left column CL and the right column CR have functionalities such as character conversion. Due to the historical background of telephones described above, keys 1 to 9 and 0 are generally recognized as areas for inputting characters and numbers. As the screen interactive device 10 may be used as a telephone, it is generally required to input codes using a three columns (in a horizontal direction) by four rows (in a vertical direction) arrangement (referred to as “twelve-keys”).

There are many types of input methods using such a code input region 23. There are, for example, a simple touch scheme, a toggle scheme, a 2-touch scheme, a flick scheme, or an “ambiguity narrowing scheme” such as T9 scheme developed by Tegic Communications, Inc. In a flick scheme (more specifically, flick+touch scheme), “D” is input if key “3” is touched once, “E” is input when key “3” is left-flicked, and “F” is input if key “3” is up-flicked. Such a character input using flick scheme is provided in iOS as a standard Japanese input method. Examples of a “code” include a character, a number, a symbol, a pictograph (emoji), and the like.

The screen interactive device 10 in FIG. 1A is of 8 inch type. The screen width in the portrait display mode is about three times the length of a thumb in a longitudinal direction, and the center column CC is far from both the left and right ends such that it is a little difficult to manipulate the center column CC with a finger.

When the screen interactive device 10 is rotated 90° from the state in FIG. 1A, the posture sensor 13 detects that the posture of the screen interactive device 10 has changed, by detecting the direction of acceleration, and the screen 24 changes from the portrait display mode to the landscape display mode accordingly.

FIG. 1B shows a display in the code input region 23 in a landscape display mode using a conventional technique. Since the height of the code input region 23 is not changed although the entire height has been reduced, the height of the non-keyboard region 26 is reduced. Moreover, touching or flicking the center column CC with a finger is more difficult than in the portrait display mode. This is because the center column CC is further from the left and right ends than the portrait display mode.

FIG. 1C shows a display in the code input region 23 in the landscape display mode according to the present invention. The height of the code input region 23 is lowered to ensure a sufficient height for the non-keyboard region 26, and the widths of the left end column C1 and the right end column C2 are narrowed and the width of the center row column CC is greatly increased. The widths of the left column CL and the right column CR are also narrowed but not as thin as the left end column C1 and the right end column C2.

This allows the user to manipulate with either of the left or right fingers on a region in the center column CC close to the finger. Since there is no substantial change except for the widening of the width of the center column CC, it is easier for the user to understand what has changed since there is only a small functional change as compared to the portrait display mode.

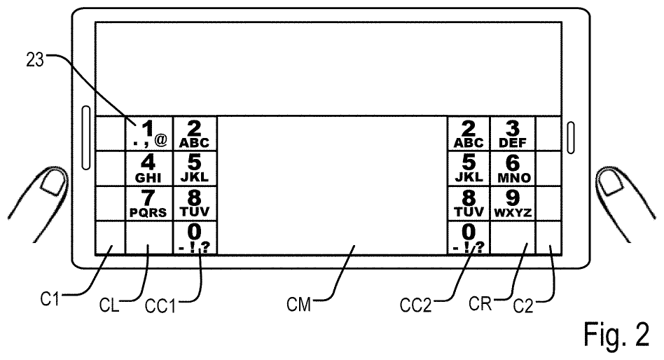

FIG. 2 shows a case in which regions of the center column CC are divided into the left side CC1 and the right side CC2 and a new central region CM is formed therebetween. The central area CM may be used as an extension to the non-keyboard region 26, and may also be used as a character input assisting display or an advertisement display. A character input assisting display displays predicted conversion candidates and other information.

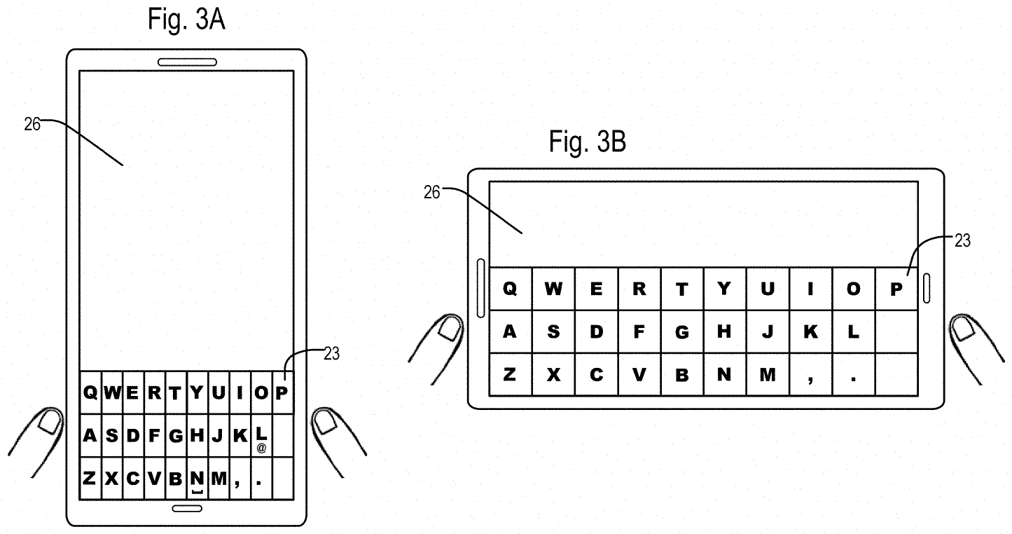

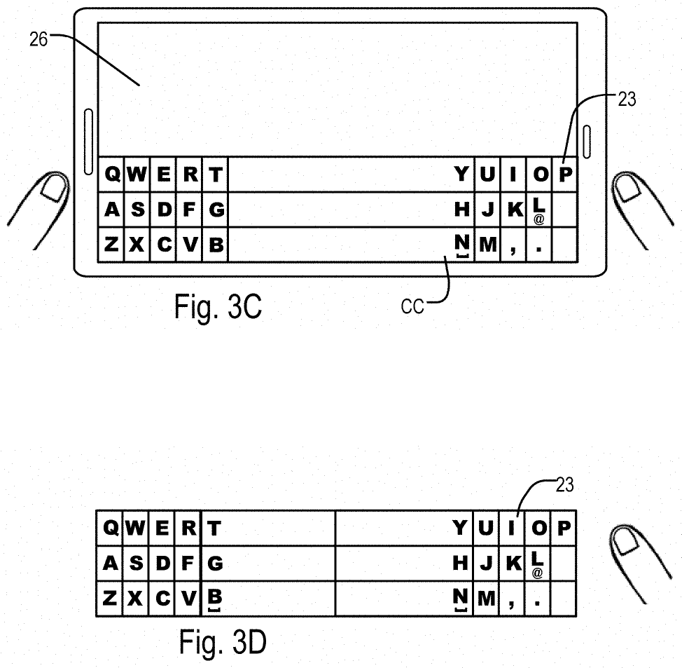

FIG. 3A shows code input using a plenteous-keys keyboard instead of a keyboard that uses twelve-keys. This plenteous-keys keyboard has keys each corresponding to each of all 26 alphabets. A key underneath “P” is used as “backspace” and a key underneath “backspace” is used as “Enter (Execute)”. Lowercase “n” is input when “N” key is touched regularly, uppercase “N” is input when “N” key is up-flicked, and “space” is input when “N” key is down-flicked. Similarly, lowercase “l” is input when “L” key is touched regularly, uppercase “L” is input when “L” key is up-flicked, and “@” is input when “L” key is down-flicked. Similarly, symbols and functions are assigned to up-flicks and down-flicks on other alphabetic keys. By making effective use of flick manipulation in this way, the number of keys displayed can be reduced as compared to the required functions.

FIG. 3B shows the display in the code input region 23 in a conventional landscape display mode after the screen interactive device 10 is rotated 90° in a manner similar to FIG. 1B. This display shows code input using a plenteous-keys keyboard instead of twelve-keys. Since the height of the code input region 23 has not changed although the entire height has changed, the height of the non-keyboard region 26 is reduced, making the device less user-friendly. Moreover, the width of each key is uniformly widened as the width of the screen 24 is widened. For this reason, keys around the center are further away from the left and right ends as compared to the portrait display mode, making those keys even more difficult to touch or flick with the finger.

FIG. 3C shows a display in the code input region 23 of a plenteous-keys keyboard in a landscape display mode according to the present invention. In addition to lowering the height of the code input region 23 in this display to ensure a sufficient height of the non-keyboard region 26, the width of the center column CC is greatly increased.

This allows the user to manipulate on regions around the center column CC with left or right finger. Since there is no substantial change except for the widening of the width of the center column CC, the functionalities have not changed significantly compared to the portrait display mode and it is easier for the user to understand what has changed. Moreover, since “space” is assigned to down-flick manipulation of “N” key in the center column CC, it is possible to input “space” similarly to methods that use traditional keyboards in which “space” is input with a wide key. Here, the center column CC includes keys “Y”, “H”, and “N”.

FIG. 3D shows only the code input region 23, where the center column CC is divided into a left side that includes keys “T,” “G,” and “B” and a right side that includes keys “Y,” “H,” and “N.” Since the keys “T,” “G,” and “B” are usually not pressed using the right hand, it is possible to achieve fundamental left side and right side rolls. At this time, it is also preferable to assign “space” to down-flick manipulation of “B” key in addition to that of “N” key. This is because there are many users who desire to manipulate “space” key with either the left and right fingers. In accordance with an aspect of the invention shown in FIGS. 1C, 3C and 3D, one column or two columns at the center is/are widened. Preferably, the widened column has width greater than 120% of that of other code inputting keys. More preferably, the widened column has width greater than 150% of that of other code inputting keys. More preferably, the widened column has width greater than 200% of that of other code inputting keys. This feature of widening one column or two columns at the center shown in FIGS. 1C, 3C and 3D can be used for input scheme that uses manipulations other than flick. Specifically, this feature can be used for input schemes that use touch manipulations.

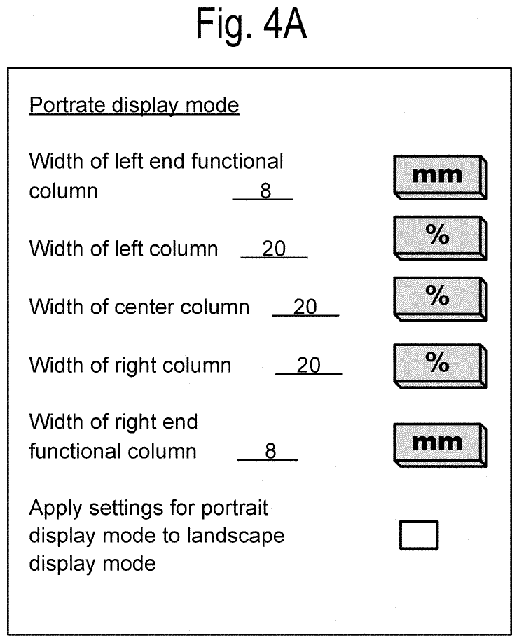

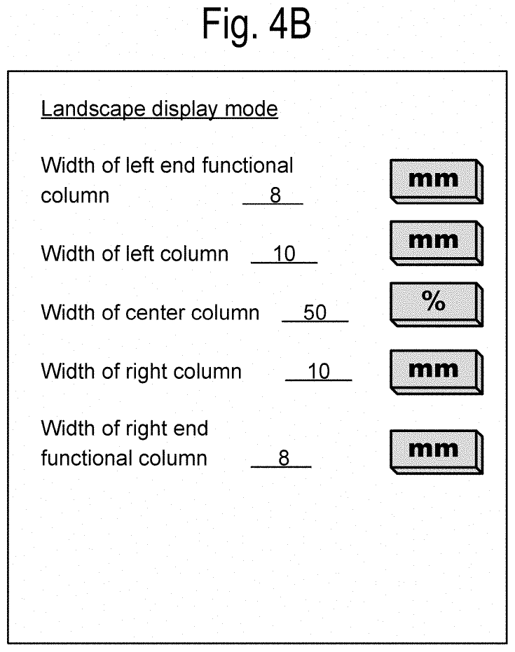

FIG. 4A shows a screen for setting various widths in the portrait display mode. When a checkbox “Apply settings for portrait display mode to landscape display mode” at the bottom of the screen in FIG. 4A is “OFF (not checked)”, the setting for various widths in the landscape display mode in FIG. 4B becomes effective. The user can set “width of left end functional column”, “width of left column”, “width of center column”, “width of right column”, and “width of left end functional column” in the code input region in a twelve-key arrangement by selecting units among % (relative percentage), mm (absolute value of distance), or px (absolute value of number of pixels). Here, the numbers in %, mm, and px are not necessarily strictly reflected, and how much they are actually reflected depends on a predetermined rule. In the case of FIG. 1A, the setting values in mm, which are absolute values, take precedence and the rest is determined by taking into account the settings values in %, which are relative values. In an embodiment that simply expands the width of the center column CC as in FIG. 1C, it is easier to reflect the user's settings as much as possible, and the description of the program code is simplified, and therefore the software can run stably.

By allowing the setting for longitudinal display mode in FIG. 4A and the setting for landscape display mode in FIG. 4B to be performed separately, it is possible to achieve appropriate displays in both the vertical and landscape display modes.

A second embodiment of the invention will be described now.

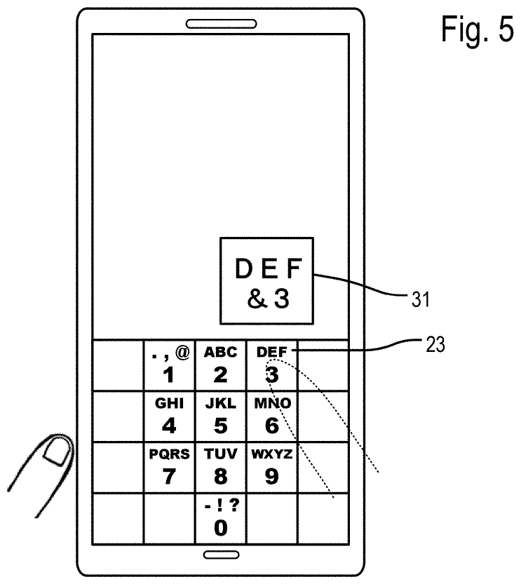

Touch-flick scheme is currently known as one of character input schemes for screen interactive devices. For example, the touch-flick scheme is adopted as a standard Japanese language IME (Input Method Editor) in iOS by Apple Computer Inc., which runs in smartphones and tablet computers. The touch-flick scheme is a most popular input scheme for inputting Japanese language in smartphones, followed by “toggle scheme” and “2-touch scheme”. In the touch-flick scheme, about 50 Japanese characters (hiragana), which are grouped into 10 groups called “gyos” are input into smartphones. Each group consists of five or less characters. In this scheme, five characters are assigned to one group, one character is assigned to “touch” manipulation each key in twelve-keys (except * and #), and the remaining four characters in the group are assigned to flick manipulations to four directions (left-flick, up-flick, right-flick, and down-flick). However, it is difficult for the user to input characters because both the touch and flick manipulations, which are different kinds of manipulation, are needed upon inputting hiragana characters, making the assignments of them difficult to be retrieved by the user unconsciously, without recollecting the assignment. It is also distressing for the user who have mastered “2-touch scheme”, which will be described later, to learn to flick in different directions as compared to positions of second touch in the 2-touch scheme. FIG. 5 shows a character input screen according to the second embodiment of the invention. As described above, when a conventional touch-flick scheme is used for inputting alphabets, “D” is input when key “3” is touched once, “E” is input when key “3” is left-flicked, and “F” is input when key “3” is up-flicked. However, in this scheme according to the second embodiment of the invention, “D”, “E” and “F” are all input with flick manipulations to particular directions among “D”, “E” and “F”, which are of the same kind of code (in this case, the kind is “alphabet”), instead of using different kinds of manipulations by combining “touch” and “flick” manipulations. This allows the user to input characters without being conscious of which kind of manipulation is to be used for inputting characters belonging to the same kind of code. It can be said that English alphabets consisted of 26 characters are grouped into eight groups according to conventional key assignments used in the U.S. The first group is “A”, “B” and “C”, the second group is “D”, “E” and “F”, . . . , the eighth group is “W”, “X”, “Y” and “Z” (see FIG. 5).

Such flick manipulations are performed by flick manipulations to five directions. The five directions are five directions chosen from “upper-left”, “up”, “upper-right”, “lower-left”, “down”, and “bottom right”. These directions may be uniformly arranged in 360°, such as a case where the directions (i.e. center direction within a specific range) are 0°, 72°, 144°, 216°, and 288° wherein “up direction” is 0°, and may have a partially biased arrangement, such as a case where the directions are 0°, 68°, 144°, 216°, 292° wherein “up direction” is 0°. In flick manipulations to five directions, flick manipulations to three directions are used on either one of the upper or lower sides, and flick manipulations to four or more directions are not used on neither of the upper nor lower sides. Accordingly, since the keys are arranged in three columns in a twelve-key arrangement, this scheme is consistent with the user's sense to use flick manipulations to three directions at the upper side or the lower side. In other words, the number three is the same in the number of directions of flick manipulations and in the number of columns. A “direction at the upper side” refers to a direction more upward than left or right direction. A “direction at the lower side” refers to a direction more downward than left or right direction.

In FIG. 5, when the user touches key “3” with a finger (indicated by a dotted line), an input assisting display 31 can be displayed in any particular region on the screen 24. In this case, the input assisting display 31 is displayed at a region apart from the touched key “3” by a predetermined distance. This is because, if the input assisting display 31 is displayed at a region apart from the touched key, it is easier to see the input assisting display even if the user's finger is located on the touched key. “D” is input with upper-left-flick, “E” is input with upper-right-flick, “F” is input with upper-right-flick, “&” is input with lower-left-flick, and “3” is input with lower-right-flick. The scheme used in FIG. 5 is referred to as “5-directions flick” scheme.

Table 1 shows assignments in this alphabetic and numeric input scheme using the “5-directions flick” scheme.

TABLE 1

| | FLICK DIRECTION | | | | | |
|---|---|---|---|---|---|---|
| | UPPER- | | UPPER- | LOWER- | LOWER- | |
| | LEFT | UP | RIGHT | LEFT | RIGHT | |
| KEY TO | 1 | . | , | @ | / | 1 |
| MANIPULATE | 2 | A | B | C | + | 2 |
| | 3 | D | E | F | & | 3 |
| | 4 | G | H | I | ( | 4 |
| | 5 | J | K | L | ) | 5 |
| | 6 | M | N | O | ′ | 6 |
| | 7 | P | Q | R | S | 7 |
| | 8 | T | U | V | ″ | 8 |
| | 9 | W | X | Y | Z | 9 |
| | 0 | − | ! | ? | : | 0 |

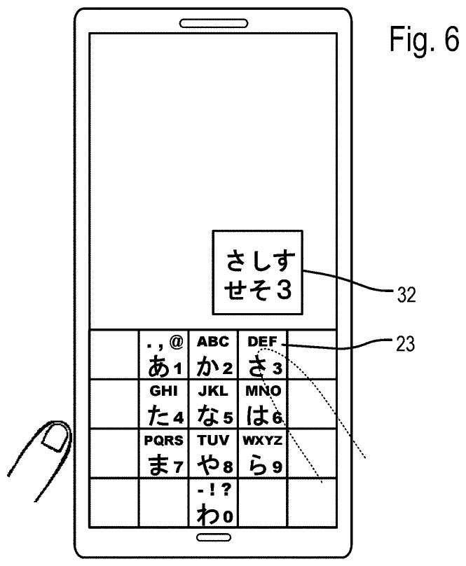

FIG. 6 shows a screen view illustrating an input scheme to which this “5-directions flick” technique is applied for inputting Japanese characters. In particular, since this flick scheme is easy to use by the user of the 2-touch scheme (also called “pocket bell (pager) scheme), this scheme is called “niko flick” scheme. “niko” means “two pieces” in Japanese.

Japanese hiragana characters are, by nature due to their combinations of one consonant and one vowel, grouped into ten groups called “gyos”, which are “a” ( [symbol] ) gyo, “ka” ( [symbol] ) gyo, “sa” ( [symbol] ) gyo, “ta” ( [symbol] ) gyo, “na” ( [symbol] ) gyo, “ha” ( [symbol] ) gyo, “ma” ( [symbol] ) gyo, “ya” ( [symbol] ) gyo, “ra” ( [symbol] ) gyo, and “wa” ( [symbol] ) gyo, and a maximum of five hiragana characteristics are assigned to each gyo. The 2-touch scheme utilizes this grouping and inputs a hiragana character among about 50 hiragana characters always with two “touch manipulations”.

“sa” ( [symbol] ) gyo consists of “sa” ( [symbol] ), “si” ( [symbol] ), “su” ( [symbol] ), “se” ( [symbol] ) and “so” ( [symbol] ) in Japanese language. In 2-touch scheme, “sa” can be input by successively touching 3 and 1, “si” by 3 and 2, “su” by 3 and 3, . . . , “so” by 3 and 5. In other words, when inputting five hiragana characters in “sa” gyo, the first keys are “3” and are the same, and the second keys are different. The second keys “1,” “2,” “3,” “4,” and “5” are in upper-left, up, upper-right, lower-left, and down directions when viewed from the center of those keys in the twelve-keys.

It can be said that users of the 2-touch scheme can retrieve these direction assignments unconsciously, and therefore it is difficult to switch to other input schemes that use direction assignments unrelated to the assignments used by the 2-touch scheme.

Accordingly, in “niko flick” scheme, a “6-directions flick” scheme, which is modified from the “5-directions flick” scheme by making use of six directions, is used. In this “6-directions flick” scheme, the same kind of manipulation, such as “touch” and “flick”, is used for the same code kind (in this case, the code kind is “hiragana”), and flick manipulations to directions corresponding to the positions of the second keys in the 2-touch scheme are used. As a result, the inventor has succeeded in developing an input scheme that does not exhaust the head, while making it easier to change over from and to the 2-touch scheme.

In FIG. 6, when the user has touched key “3” with a finger (indicated by a dotted line), the input assisting display 31 can be displayed in any area on the screen 24. In this case, the input assisting display 31 is displayed at a region apart from the touched key “3” by a predetermined distance. The input assisting display 31 displays characters that are to be input by flick manipulations on the key “3” at regions corresponding to the directions of the flick manipulations. Accordingly, “sa” is input with upper-left-flick, “si” is input with up-flick, “su” is input with upper-right-flick, “se” is input with lower-left flick, “so” is input with down-flick, and “3” is input with lower-right flick. A first kind of code, hiragana, is input using up-flick, upper-right-flick, lower-left flick and down-flick and a second kind of code, number, is input using lower-right flick, which is a manipulation not used for inputting the first kind of code, hiragana. In this way, it is possible to avoid manipulation confusions among different kinds of codes.

Table 2 shows assignments of the input scheme for hiragana and numbers according to this “nico-flick” scheme (referred to as “six-directions nico-flick” scheme due to the use of six-directions flick manipulations).

TABLE 2

| | | FLICK DIRECTION | | | | | |
|---|---|---|---|---|---|---|---|
| | | UPPER- | | UPPER- | LOWER- | | LOWER- |
| | | LEFT | UP | RIGHT | LEFT | DOWN | RIGHT |
| KEY TO | 1 | [symbol] (“a”) | [symbol] (“i”) | [symbol] (“u”) | [symbol] (“e”) | [symbol] (“o”) | 1 |
| MANIPULATE | 2 | [symbol] (“ka”) | [symbol] (“ki”) | [symbol] (“ku”) | [symbol] (“ke”) | [symbol] (“ko”) | 2 |
| | 3 | [symbol] (“sa”) | [symbol] (“si”) | [symbol] (“su”) | [symbol] (“se”) | [symbol] (“so”) | 3 |
| | 4 | [symbol] (“ta”) | [symbol] (“ti”) | [symbol] (“tu”) | [symbol] (“te”) | [symbol] (“to”) | 4 |
| | 5 | [symbol] (“na”) | [symbol] (“ni”) | [symbol] (“nu”) | [symbol] (“ne”) | [symbol] (“no”) | 5 |
| | 6 | [symbol] (“ha”) | [symbol] (“hi”) | [symbol] (“hu”) | [symbol] (“he”) | [symbol] (“ho”) | 6 |
| | 7 | [symbol] (“ma”) | [symbol] (“mi”) | [symbol] (“mu”) | [symbol] (“me”) | [symbol] (“mo”) | 7 |
| | 8 | [symbol] (“ya”) | ( | [symbol] (“yu”) | ) | [symbol] (“yo”) | 8 |
| | 9 | [symbol] (“ra”) | [symbol] (“ri”) | [symbol] (“ru”) | [symbol] (“re”) | [symbol] (“ro”) | 9 |
| | 0 | [symbol] (“wa”) | [symbol] (“wo”) | [symbol] (“n”) | `` | ° | 0 |

Such a “6-directions nico-flick” scheme can also be implemented with “5-directions flick” scheme. Table 3 shows assignments of such a hiragana input scheme that uses “5-directions nico-flick” scheme.

TABLE 3

| | | FLICK DIRECTION | | | | |
|---|---|---|---|---|---|---|
| | | UPPER- | | UPPER- | LOWER- | LOWER- |
| | | LEFT | UP | RIGHT | LEFT | RIGHT |
| KEY TO | 1 | [symbol] (“a”) | [symbol] (“i”) | [symbol] (“u”) | [symbol] (“e”) | [symbol] (“o”) |
| MANIPULATE | 2 | [symbol] (“ka”) | [symbol] (“ki”) | [symbol] (“ku”) | [symbol] (“ke”) | [symbol] (“ko”) |
| | 3 | [symbol] (“sa”) | [symbol] (“si”) | [symbol] (“su”) | [symbol] (“se”) | [symbol] (“so”) |
| | 4 | [symbol] (“ta”) | [symbol] (“ti”) | [symbol] (“tu”) | [symbol] (“te”) | [symbol] (“to”) |
| | 5 | [symbol] (“na”) | [symbol] (“ni”) | [symbol] (“nu”) | [symbol] (“ne”) | [symbol] (“no”) |
| | 6 | [symbol] (“ha”) | [symbol] (“hi”) | [symbol] (“hu”) | [symbol] (“he”) | [symbol] (“ho”) |
| | 7 | [symbol] (“ma”) | [symbol] (“mi”) | [symbol] (“mu”) | [symbol] (“me”) | [symbol] (“mo”) |
| | 8 | [symbol] (“ya”) | ( | [symbol] (“yu”) | ) | [symbol] (“yo”) |
| | 9 | [symbol] (“ra”) | [symbol] (“ri”) | [symbol] (“ru”) | [symbol] (“re”) | [symbol] (“ro”) |
| | 0 | [symbol] (“wa”) | [symbol] (“wo”) | [symbol] (“n”) | `` | ° |

In the “five-directions nico-flick” scheme, flick manipulations are more reliable as compared to the “six-directions nico-flick” scheme although there is a need to input numbers using other kind of manipulation different from that for hiragana characters.

In both the “6-directions niko-flick” and the “5-directions niko-flick” schemes, flick manipulations to three directions are used on the upper side or the lower side, and flick manipulations to four or more directions are not used on neither the upper side nor the lower side. Here, “upper side” refers to directions oriented upwards with respect to the horizontal line and “lower side” refers to directions oriented downwards with respect to the horizontal line. Accordingly, since the keys are arranged in three columns in a twelve-key arrangement, the use of flick manipulations to three directions at the upper side or the lower side is in accordance with the user's sense in relation to the key arrangement.

A third embodiment of the invention will be described now.

There are Input Method Editors “IMEs” that display several predicted candidates based on previous inputs and causes the user to select an appropriate one among such candidates.

However, if the predicted candidate display is displayed on a region difficult to manipulate on it, making a selection is difficult for the user.

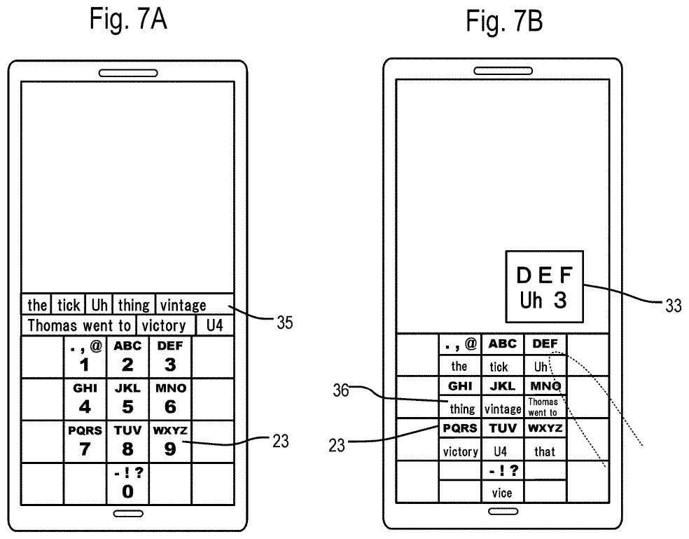

FIG. 7A shows a screen view showing a predicted candidate display according to a conventional “ambiguity narrowing technique” for alphabets. We suppose that the user has touched key “TUV8” in the code input region 23 and then touched “GHI4” in order to input using the “ambiguity narrowing technique” such as T9 scheme. In an “ambiguity narrowing technique” for alphabets and Japanese kana-kanji conversion, the system provides predicted candidates in response to input manipulations by the user. At this point, there are sixteen input candidates. This number is obtained by multiplying four candidates for “TUV8” by four candidates for “GHI4”. As the input progresses, the candidates that are predicted to be input are narrowed down based on possibility of inputs. Such predicted candidates are displayed on two rows in the predicted candidate display region 35 and can be selected by the user. However, the predicted candidate display region 35 in FIG. 7A is far from the region where the user mainly moves the finger in the code input region 23, and therefore it is difficult to move the finger to the predicted candidate display region 35 especially if the screen interactive device 10 is large.

FIG. 7B shows a screen view illustrating a predicted candidate display according to the third embodiment of the invention. In FIG. 7B, similarly, we assume that the user has touched key “TUV 8” in the code input region 23, and touched “GHI 4” thereafter. Then, predicted candidate display is displayed in intra-key predicted candidate display regions 36 arranged inside each key region in the code input region 23 that has a twelve-key arrangement. The intra-key predicted candidate display regions 36 is in a region where the user mainly moves his/her fingers. The arrangement of the intra-key predicted candidate display regions 36 correspond to the key arrangement of the twelve-keys arrangement. Although the width of the center column in FIG. 7B is that of a conventional arrangement, the widths of the columns as in FIGS. 1C, 2, 3C and 3D are preferable. In this case, manipulations on the center column are easier.

When “5-directions flick” described above is used and key “DEF” is touched, the input assisting display 33 is displayed on a predetermined region. If lower-left-flick is performed on the key “DEF”, “Uh”, which is displayed on the intra-key predicted candidate display region 36 for key “DEF”, can be selected and be input to the device. The user is now able to select predicted candidates within a region where the user mainly moves his/her fingers, that is, within a twelve-keys region.

A fourth embodiment of the invention will be described now.

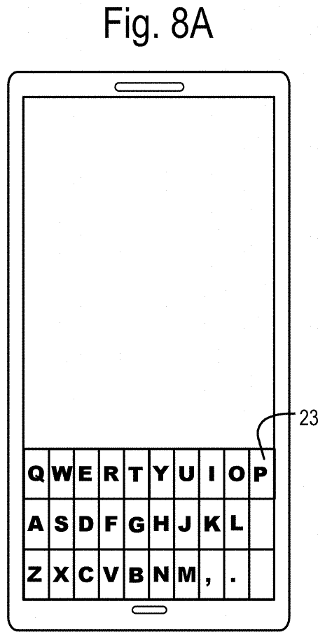

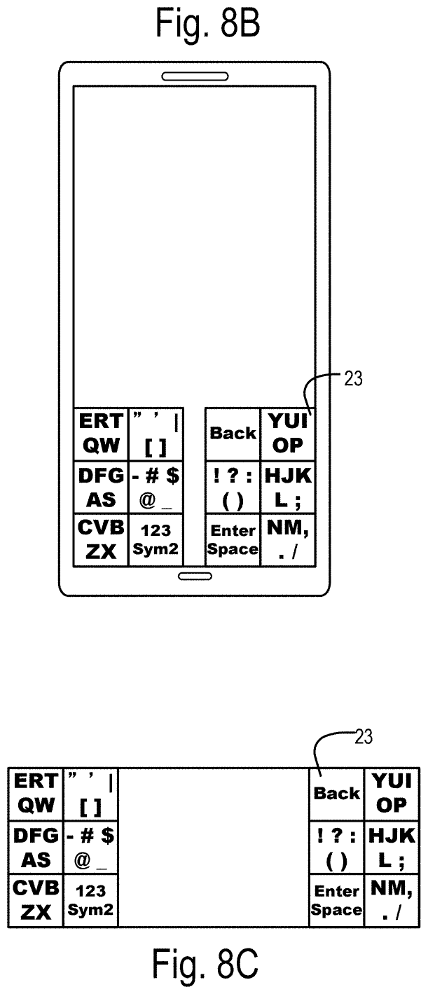

FIG. 8A shows a conventional alphabetic plenteous-keys keyboard. As a consequence of displaying ten keys on the width of the screen, the area of each key is small, making it difficult to touch the keys accurately with fingers. However, many users prefer to use the QWERTY arrangement, which they are familiar with. In QWERTY arrangements, for example, Y and Z are usually switched in Germany, and there are arrangements that have different assignments of codes, such as DVORAK arrangement or JIS-kana arrangement. All of these are referred to herein as “plenteous-keys keyboard arrangements.” A “plenteous-keys keyboard arrangement” indicates a keyboard arrangement in which 26 or more keys are assigned to an array of 7 or more columns by 3 or more rows.

FIG. 8B shows a keyboard region in which 26 alphabets are assigned to regions of 2 columns by 3 rows in the code input region by utilizing flick manipulations. This scheme is referred to as “ERT-QW flick scheme”. The entire keyboard region is 4 columns by 3 rows, and is divided into two regions, each consisted of 2 columns by 3 rows. One column in left 2 columns by 3 rows region is a left end column and one column in right 2 columns by 3 rows region is a right end column. This is because if a key is close to the left or right end portion, such a key is close to the finger, resulting in less mistakes in manipulation.

Table 4 shows characters that are input when flick manipulations are performed on the keys.

TABLE 4

| | | FLICK DIRECTION | | | | |
|---|---|---|---|---|---|---|
| | | UPPER- | | UPPER- | LOWER- | LOWER- |
| | | LEFT | UP | RIGHT | LEFT | RIGHT |
| KEY TO | ERT-QW | E | R | T | Q | W |
| MANIPULATE | DFG-AS | D | F | G | A | S |
| | CVB-ZX | C | V | B | Z | X |
| | YUI-OP | Y | U | I | O | O |
| | HJK-L; | H | J | K | L | ; |
| | NM,-./ | N | M | , | . | / |

“E” is input if the top key in the left end column is upper-left-flicked, “R” if up-flicked, “T” if upper-right flicked, “E” if lower-left-flicked, and “W” if lower-right flicked. In this “ERT-QW flick scheme”, 26 alphabets can be assigned on a code input region of 2 columns by 3 rows without causing the user to be conscious very much of the change from the QWERTY arrangement as in FIG. 8A since the arrangement for alphabet in this “ERT-QW flick scheme” is based on the QWERTY arrangement. Therefore, the area of each key can be large, and the keys can be arranged within a region that is easy to manipulate.

FIG. 8C shows a code input region when the screen interactive device in FIG. 8B is displayed in the landscape display mode. Since there is only one column for code inputting at each of the left and right, it can be seen that the keys are positioned at positions where the device can be manipulated easy even if the device is displayed in the landscape display mode. It should be noted that keys in one column may be separated from each other or the lateral positions thereof may be slightly misaligned.

A fifth embodiment of the invention will be described now.

Some people want to manipulate the screen interactive device with both hands and some other people want to manipulate it with one hand. When manipulating with one hand, the region where the user can move the finger comfortably is very limited. At that time, it may be necessary to hold the screen interactive device with one hand.

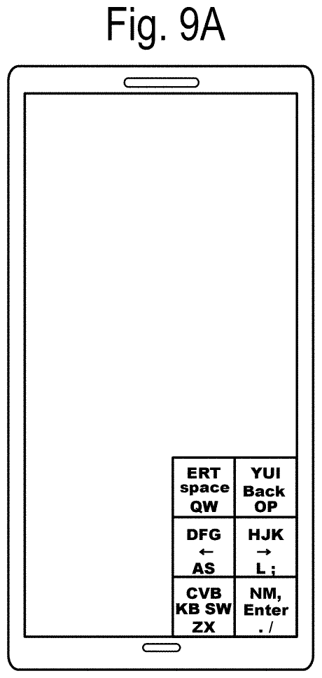

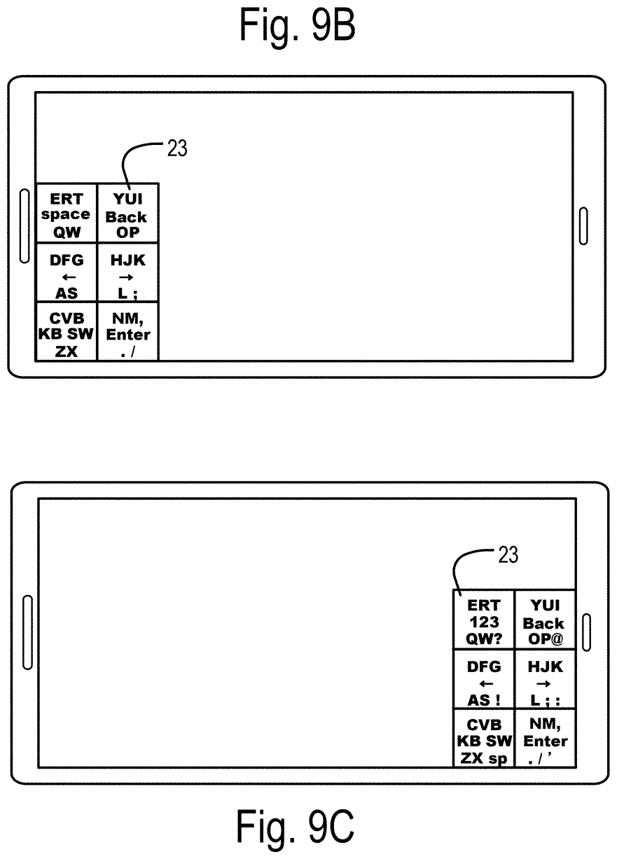

FIG. 9A shows a device that allows one-hand manipulation by applying the “ERT-QW flick scheme” described above without causing the user to be conscious very much of the change from a QWERTY arrangement. This scheme is referred to as “ERT-QW flick scheme for one-hand manipulation.” In FIG. 9A, the user can perform input manipulation using only the right hand thumb.

Table 5 shows characters to be input when performing touch and flick manipulations on respective keys.

TABLE 5

| | | | FLICK DIRECTION | | | | |
|---|---|---|---|---|---|---|---|
| | | | UPPER- | | UPPER- | LOWER- | LOWER- |
| | | TOUCH | LEFT | UP | RIGHT | LEFT | RIGHT |
| KEY TO | ERT-QW | SPACE | E | R | T | Q | W |
| MANIPULATE | DFG-AS | LEFT CURSOR | D | F | G | A | S |
| | CVB-ZX | KEYBOARD | C | V | B | Z | X |
| | | SWITCH | | | | | |
| | YUI-OP | BACKSPACE | Y | U | I | O | O |
| | HJK-L; | RIGHT | H | J | K | L | ; |
| | | CURSOR | | | | | |
| | NM,-./ | ENTER | N | M | , | . | / |

In FIG. 9B, the device is in a landscape display mode and the user can perform input manipulation with only the left hand thumb.

In FIG. 9C, a “6-directions flick”, instead of “5-directions flick”, is used to select from six characters. Such a keyboard allows the user to input 26 alphabets with only six keys without causing the user to be conscious very much of the change from the QWERTY arrangement since the arrangement for alphabet is based on the QWERTY arrangement.

A sixth embodiment of the invention will be described now.

In the “ERT-QW flick scheme” described above, the user is caused to be somewhat aware of the change from the QWERTY arrangement such as that shown in FIG. 8A, and some user may feel uncomfortable with this. Of course, the “ERT-QW flick scheme” can be “QWE-RT flick scheme” such that Q is input upon an upper-left-flick, W is input upon an up-flick, and E is input upon an upper-right-flick on “QWE-RT” key. The user may get used to “QWE-RT flick scheme” more because “QWE-RT” order is close to QWERTY order.

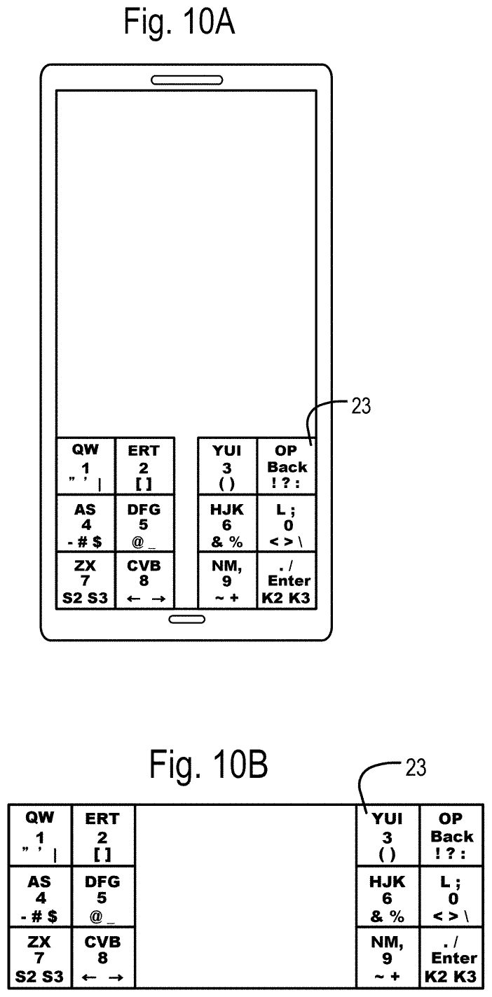

FIG. 10A shows a “QW-ERT flick scheme” that aims to minimize the change from the QWERTY arrangement. Regarding QWERT, the user can input Q and W by upper-left and upper-right flick manipulations on a left “QW1” key, respectively, and the user can input E, R, and T by upper-left, up and upper-right flick manipulations on a “ERT2” key at the right of the “QW1” key. In other words, all Q, W, E, R and T codes can be input by manipulation of an upper-side flick in correspondence with the order of Q, W, E, R and T. Compared to a QWERTY arrangement such as that shown in FIG. 8A, the user can consider that this change is merely a change from “touch on individual keys positioned in accordance with the QWERTY arrangement” to “flick to directions corresponding to positions in the QWERTY arrangement,” thereby minimizing the change the user perceives from the QWERTY arrangement.

As the number of keys has increased compared to the “ERT-QW flick scheme”, all 10 numbers from 0 to 9 can be assigned to the “touch” on different keys.

Table 6 shows characters to be input when performing touch and flick manipulations on respective keys.

TABLE 6

| | | | FLICK DIRECTION | | |
|---|---|---|---|---|---|
| | | | UPPER- | | UPPER- |
| | | TOUCH | LEFT | UP | RIGHT |
| KEY TO | QW | 1 | Q | | W |
| MANIPULATE | ERT | 2 | E | R | T |
| | AS | 4 | A | | S |
| | DFG | 5 | D | F | G |
| | ZX | 7 | Z | | X |
| | CVB | 8 | C | V | B |
| | YUI | 3 | Y | U | I |
| | OP | BACKSPACE | O | | P |
| | HJK | 6 | H | J | K |
| | L; | 0 | L | | ; |
| | NM, | 9 | N | M | , |
| | . / | ENTER | . | | / |

FIG. 10B shows a code input region in the landscape display mode. It can be seen that the keys are close to the left or right ends of the screen and are in positions where they can be easily pressed by the user's fingers even in the landscape display mode.

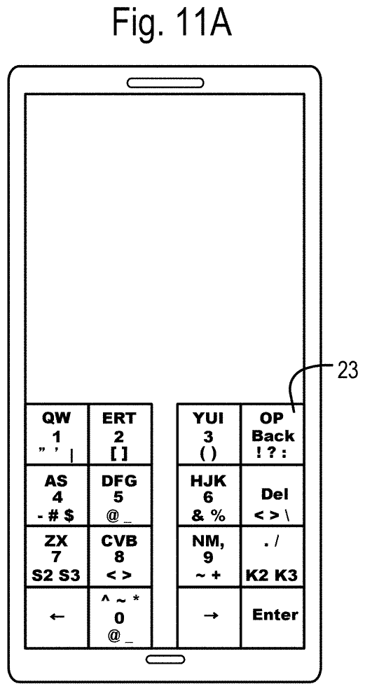

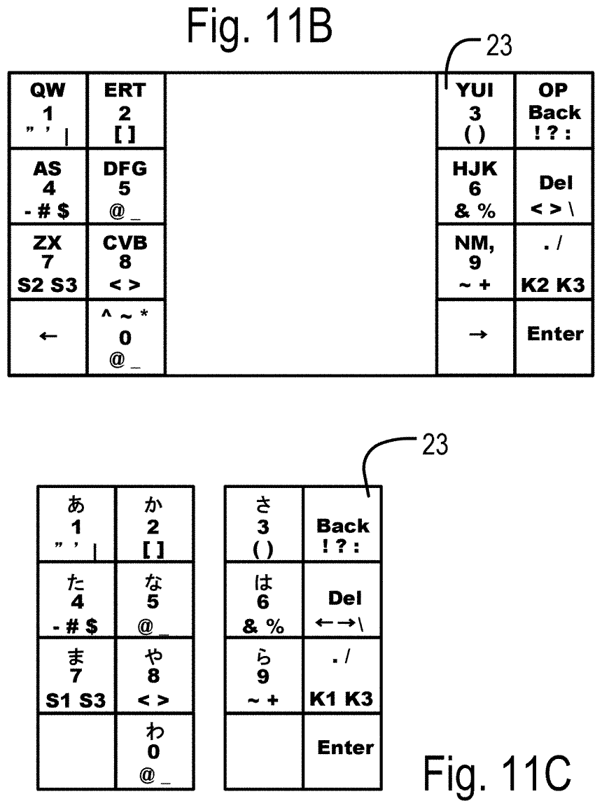

FIG. 11A shows a 4-rows implementation of the “QW-ERT flick scheme”. It can be seen that the left three columns by four rows correspond to twelve-keys. Since this scheme has four rows, “0” can be assigned to the fourth row, and therefore it is possible to configure a twelve-key arrangement for the numbers 0 to 9.

FIG. 11B shows a screen in the landscape display mode. It can be seen that the keys are close to the left or right end of the screen and are in positions where they are easily pressed by the user's fingers even in the landscape display mode.

In the “QW-ERT flick scheme” for alphabets and numbers in FIG. 11A, when key “ZX7” is lower-left-flicked (manipulation of “S2”), the device switches to a Japanese input mode shown in FIG. 11C. In such a Japanese input mode, the user can input Japanese hiragana according to a Japanese input scheme such as the 5-directions flick scheme, 6-directions flick scheme, touch flick scheme, toggle scheme, and toggle flick scheme, and then convert (transform) the hiragana characters thus input to a character string that may contain kanji characters (Chinese characters) partially or entirely. In this Japanese input mode, the numbers can be input by simply touching a key, and different kinds of manipulations, in this case, touch and flick, are not assigned among the same kind of code (e.g. numbers, alphabets, hiragana). In other words, “touch” is only used for inputting a number, and “flick” is only used for inputting a hiragana character on keys 0 to 9 in FIG. 11C.

A seventh embodiment of the invention will be described now. In FIG. 11C, the keyboard region consists of two columns by four rows on the left and two columns by four rows on the right. This is referred to as “split twelve-key scheme.” The keyboard region in general contains a twelve-key arrangement of 3 columns by 4 rows. In addition, several functions are assigned to touch and flick manipulations on keys in the right end column. For example, on “Del” key, “Delete” is assigned to “touch” manipulation, left cursor movement is assigned to “lower-left-flick” manipulation, and right cursor movement is assigned to “down-flick” manipulation. In this “split twelve-key scheme”, it is easy to input the keys even when the code inputting region is split into the left side and the right side in, for example, the landscape display mode, since the key region is close to the user's fingers, while enabling a traditional twelve-key input.

The present invention is not limited to the above-described embodiments, and one skilled in the art may envisage various simple modifications or variations without departing from the scope of the invention as defined by the appended claims. Moreover, any combination of the above-described embodiments may be possible even if such combination is not explicitly described herein.

1. A method for providing a code input interface to a user by means of a twelve-keys arrangement consisted of three columns by four rows in a screen interactive device in which display on a screen changes and the user manipulates on the screen in accordance with the display of the screen, the method comprising:
providing a code input region for inputting codes on the screen, the code input region comprising n key regions, the codes are divided into n number of groups, each group including m or less codes as members;
allowing a flick manipulation of the user on the key region to m number of directions;
determining which kind of flick manipulation and on which key region the flick manipulation is performed; and
determining the code to be input according to the kind and the key region thus determined, wherein
the m types of flick manipulations to the m directions include three or more flick manipulations on either one of upper and lower sides, and
four or more flick manipulations to four or more directions are not used on either the upper or lower sides.

2. The method according to claim 1, wherein
n is 6 to 10,
Japanese hiragana characters are respectively assigned to one of the n key regions,
each of the n key regions corresponds to one of first to nth group of Japanese hiragana characters, and
the m directions are five or six directions selected from six directions consisted of upper-left, up, upper-right, lower-left, down and lower-right directions.

3. The method according to claim 1, wherein
n is 6 to 10,
alphabet characters are respectively assigned to one of the n key regions,
each of the n key regions corresponds to one of first to nth group of alphabet characters, and
the m directions are three to six directions selected from six directions consisted of upper-left, up, upper-right, lower-left, down and lower-right directions.

4. The method according to claim 3, wherein
n is 6.

5. A method for providing a code input interface to a user in a screen interactive device in which screen display changes and the user manipulates on the screen, the method comprising the steps of:
providing a keyboard region comprising a plurality of key regions on the screen;
determining, in response to a flick manipulation performed by the user on the key regions, which key region is manipulated in the keyboard region and which kind of manipulation is manipulated; and
determining a code to be input in accordance with the determination of the key region and the kind of manipulation; wherein
the screen interactive device can display the code input region in the screen having a substantially rectangular shape in both a portrait display mode and a landscape display mode,
the keyboard region includes a left key region consisted of two or more columns at the left side and a right key region consisted of two or more columns at the right side in the portrait display mode, and the left key region is displayed at the left side and the right key region is displayed at the right side in the landscape display mode as well, and
in the landscape display mode, width of an outermost column in the left key region and width of an outermost column in the right key region are enlarged as compared to the portrait display mode at an increase rate less than an increase rate of the width of innermost columns in the left and right key regions.

6. The method according to claim 5, wherein
ten numbers of 1, 2, 3, 4, 5, 6, 7, 8, 9 and 0 are assigned to ten key regions in the keyboard region.

7. The method according to claim 5, wherein
codes on keys on a top row at a left side in a plenteous-keys keyboard arrangement are grouped into two groups and these two groups are respectively assigned to two keys on a first row in the left keyboard region,
codes on keys on a center row at a left side in the plenteous-keys keyboard arrangement are grouped into two groups and these two groups are respectively assigned to two keys on a second row in the left keyboard region,
codes on keys on a bottom row at a left side in the plenteous-keys keyboard arrangement are grouped into two groups and these two groups are respectively assigned to two keys on a third row in the left keyboard region,
codes on keys on a top row at a right side in the plenteous-keys keyboard arrangement are grouped into two groups and these two groups are respectively assigned to two keys on a first row in the right keyboard region,
codes on keys on a center row at a right side in the plenteous-keys keyboard arrangement are grouped into two groups and these two groups are respectively assigned to two keys on a second row in the right keyboard region,
codes on keys on a bottom row at a right side in the plenteous-keys keyboard arrangement are grouped into two groups and these two groups are respectively assigned to two keys on a third row in the right keyboard region, and
in all said assignments, at most three said codes are assigned to each key and the codes are determined according to flick manipulations to different directions on the assigned key,
said directions are all either at the upper side or the lower side for codes belonging to the same kind.

8. The method according to claim 5, wherein
codes on keys on a top row at a left side in a plenteous-keys keyboard arrangement are assigned to one key on a first row in the left keyboard region,
codes on keys on a center row at a left side in the plenteous-keys keyboard arrangement are assigned to one key on a second row in the left keyboard region,
codes on keys on a bottom row at a left side in the plenteous-keys keyboard arrangement are assigned to one key on a third row in the left keyboard region,
codes on keys on a top row at a right side in the plenteous-keys keyboard arrangement are assigned to one key on a first row in the right keyboard region,
codes on keys on a center row at a right side in the plenteous-keys keyboard arrangement are assigned to one key on a second row in the right keyboard region,
codes on keys on a bottom row at a right side in the plenteous-keys keyboard arrangement are assigned to one key on a third row in the right keyboard region, and
in all said assignments, at most five said codes are assigned to each key and the codes are determined according to flick manipulations to different directions on the assigned key.

9. A method for providing a code input interface to a user in a screen interactive device in which display on a screen changes and the user manipulates on the screen in accordance with the display of the screen, the method comprising:
providing a code input region for inputting codes on the screen, the code input region comprising n key regions;
allowing a manipulation of the user on the key region;
determining on which key region the manipulation is performed; and
determining the code to be input according to the key region thus determined, wherein
the code input region includes three or more rows of key regions in a vertical direction,
each of the rows of key regions includes three or more key regions in a horizontal direction, and
one or two key region at a center of each row of the key regions has width greater than 120% of other key regions in the row such that a part of said one or two key region is close to one lateral end of the screen as compared to a case where all key regions in the row have the same width.

10. The method according to claim 9, wherein
the code input region includes 20 or more key regions corresponding to 20 or more alphabets.

11. The method according to claim 10, wherein
“B” and “N” key regions are the key regions having greater width.

12. The method according to claim 10, wherein
a space code can be input by a flick manipulation on the key region having greater width.
